(19) United States
(12) Patent Application Publication
(10) Pub. No.: US 2025/0272707 A1
(43) Pub. Date: Aug. 28, 2025

(54) PRICE ELASTICITY ANALYSIS AND PREDICTION METHOD AND MODEL BASED ON DEEP LEARNING

(71) Applicant: Jinan Mingquan Digital Commerce Co., Ltd., Jinan (CN)

(72) Inventors: Yong ZHOU, Jinan (CN); Li CAI, Jinan (CN); Zongfang YANG, Jinan (CN); Wenyu LI, Jinan (CN)

(73) Assignee: Jinan Mingquan Digital Commerce Co., Ltd., Jinan (CN)

(21) Appl. No.: 18/920,965

(22) Filed: Oct. 20, 2024

(30) Foreign Application Priority Data
Feb. 23, 2024 (CN) 202410201587.6

(51) Int. Cl. G06Q 30/0201

(52) U.S. Cl. CPC G06Q 30/0206

(57) ABSTRACT

The provided are a price elasticity analysis and prediction method and model based on deep learning. The model consists of a CNN layer and an RNN layer. The method comprises the following steps: S1, collecting historical data and merging the historical data into a multi-dimensional time series dataset; S2, extracting sentiment data and trend data from market news and social media; S3, inputting the data obtained into CNN for data preprocessing and feature extraction; S4, inputting the feature extracted by CNN into RNN for time series analysis; S5, training and optimizing model: using Adam algorithm to adjust the learning rate adaptively, and combining the momentum method and RMSProp algorithm to improve the generalization ability and prediction accuracy of the model. The provided combines the advantages of CNN and RNN, which can understand and predict the complex relationship between price and market behavior more comprehensively and accurately.

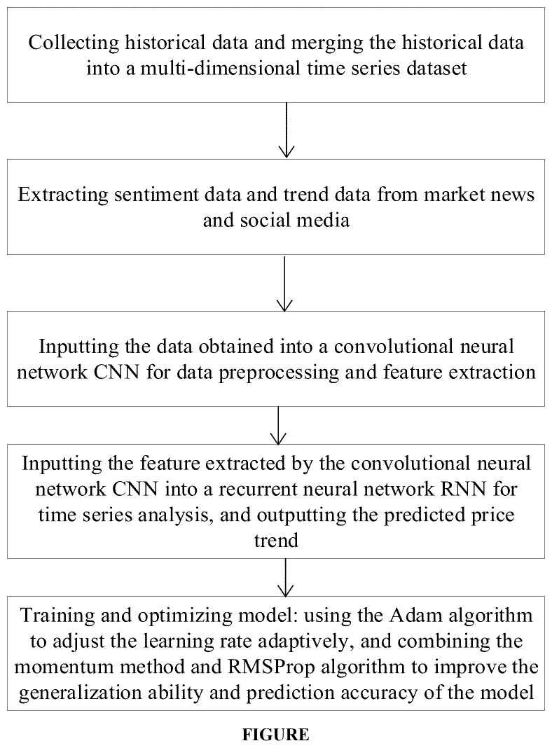

### CROSS-REFERENCE TO THE RELATED APPLICATIONS

This application is based upon and claims priority to Chinese Patent Application No. 202410201587.6, filed on Feb. 23, 2024, the entire contents of which are incorporated herein by reference.

### TECHNICAL FIELD

The invention relates to the field of artificial intelligence and economic forecasting technology, in particular to a price elasticity analysis and prediction method and model based on deep learning.

### BACKGROUND

In economics, price elasticity refers to the degree of response of demand or supply to price changes. Traditional price elasticity models use simplified assumptions and linear regression analysis to calculate, however, the accuracy and reliability of these models in dealing with complex market dynamics and nonlinear price-demand relationships are limited.

In recent years, some new methods and techniques have been introduced to understand market behavior better and predict the impact of price changes. For example, the price elasticity model based on machine learning can consider more factors and deal with nonlinear price-demand relationships. These models use a large amount of data and complex algorithms to analyze the dynamic characteristics of the market, thus providing more accurate and reliable prediction results.

In addition, in order to cope with the uncertainty and changes in the market, some researchers have also proposed flexibility elasticity models. These models take into account the behavior and decision-making of market participants, as well as the impact of external factors, so as to more fully understand the changes in price elasticity.

In general, with the continuous development of technology and the deepening of research, the price elasticity model is constantly evolving and improving. By adopting more complex and accurate methods, we can understand the laws of market operation better and make more informed decisions.

### SUMMARY

The purpose of this invention is to provide a price elasticity analysis and prediction method and model based on deep learning, by merging the advantages of CNN and RNN, it can understand and predict the complex relationship between price and market behavior more comprehensively and accurately, improve the prediction performance of price elasticity model, and help enterprises make more informed decisions.

In order to achieve the above purpose, the invention adopts a price elasticity analysis and prediction method based on deep learning, which comprises the following steps:
S1, collecting historical data and merging the historical data into a multi-dimensional time series dataset; the historical data comprise a historical price change and a sales volume change;
S2, using natural language processing technology to extract sentiment data and trend data from market news and social media;
S3, inputting the data obtained by S1 and S2 into a convolutional neural network CNN for data preprocessing and feature extraction to capture key information;
S4, inputting a feature extracted by the convolutional neural network CNN into a recurrent neural network RNN for time series analysis, and outputting a predicted price trend;
S5, training and optimizing model: using an Adam algorithm to adjust a learning rate adaptively, and combining a momentum method and RMSProp algorithm to improve a generalization ability and prediction accuracy of the model.

Preferably, S3 is as follows:
S31, data cleaning and preprocessing: comprising a removal of stop words, and irrelevant punctuations, and performing a simplified processing through stemming and word vectorization;
S32, performing a sentiment prediction through the sentiment analysis model: inputting preprocessed data, processing sequence data through a long short-term memory (LSTM) layer, capturing a time-dependent characteristic in text data, and finally outputting a result of sentiment classification through a dense connection layer;
S33, trend analysis: using text mining and a machine learning algorithm to identify a trend and pattern in the market; specifically, based on the preprocessed data, using a classification algorithm to identify sentiment tendencies, using a clustering algorithm to find different types of market behaviors, and using a time series analysis method to predict the price trend or a market trend;
S34, feature extraction: according to a result of sentiment and trend analysis, extracting useful features from the text data;
S35, feature fusion: fusing extracted feature data with traditional quantitative market data to form a feature set.

Preferably, S34 is as follows:
S341, integrating a sentiment analysis result: obtaining a sentiment score of each text data, calculating an average sentiment score or classifying the sentiment scores according to a sentiment trend, and obtaining a sentiment characteristic;
S342, integrating a trend analysis result: identifying trend words or phrases, and calculating a frequency of trend words or phrases in each text data, or identifying trend words or phrases with abnormally increased frequency;
S343, constructing a feature vector: merging a frequency of sentiment scores and trend words into a feature vector, and each text data corresponds to a feature vector;
S344, according to an analysis objective, performing a feature selection and optimization.

Preferably, in S35:

The traditional quantitative market data comprise: price data, trading volume, economic indicators, and interest rate data;
the steps of feature fusion are as follows: first, performing a data alignment for text data features and quantitative market data on a timeline, then normalizing or standardizing the feature data, and finally merging normalized feature data and quantitative market data into a feature set.

Preferably, S5 is as follows:
S51, defining a model structure, initializing weights and bias parameters of a CNN layer and an RNN layer in the model;
S52, selecting an Adam optimization algorithm: setting an initial learning rate, a momentum parameter, and a RMSProp parameter;
S52, defining a loss function: comprising a mean square error MSE function or a cross-entropy loss function, evaluating the prediction accuracy of the model;
S53, performing an iterative training for each batch of training data: inputting the data into the model, and performing a forward calculation through the CNN layer and the RNN layer to obtain a prediction result; according to the loss function, calculating a difference between the prediction result of the model and an actual result; then calculating a gradient of the loss function relative to each parameter; finally, updating the model parameters according to the gradient calculated by the Adam algorithm.
S54, applying deviation correction in the Adam algorithm to reduce an impact of initialization;
S55, model evaluation and adjustment: after each iteration cycle, evaluating a performance of the model using a validation dataset, and adjusting parameters according to the performance of the model on the validation set;
S56, repeating S53 until the model performance reaches a satisfactory level or reaches a predetermined number of iterations;
S57, model testing: testing a final trained model on a testing set to evaluate its performance on unseen data.

The invention also adopts a price elasticity analysis prediction model based on deep learning, comprising a convolutional neural network CNN layer for feature extraction and a recurrent neural network RNN layer for prediction;

CNN layer: it comprises an input layer, several convolutional layers for extracting input data features, an activation layer for enabling the network to learn complex patterns, a pooling layer for reducing a spatial dimension of a feature map, a fully connected layer for making final decisions, a normalization layer for improving a convergence speed of the model, a discarding layer for preventing overfitting of the model, and an output layer.

RNN layer: it comprises an input layer for inputting CNN extracted features, a loop layer for processing CNN extracted features, and an output layer for outputting the prediction result.

Preferably,
1) in the CNN layer
convolution layer: by applying several different convolution kernels on the dataset, the model learns various features from basic price changes to complex consumer behavior patterns, and automatically identifies and extracts features of the complex relationship between price data and promotions, seasonal changes, and competitor prices;
activation layer: it is after the convolution layer, setting all negative values to zero by introducing ReLU, which increases a nonlinear ability of the model and solves a nonlinear problem of the network;
pooling layer: in a form of maximum pooling, summarizing information of adjacent feature points by taking a maximum value or average value to extract significant price fluctuations or trend characteristics, retaining important price change characteristics, reducing the number of parameters and calculations of subsequent layers, and controlling over-fitting;
fully connected layer: it is located at an end of the network, by flattening the feature map after several convolutions and pooling into vectors, calculating the impact of price changes on demand, and outputting a predicted price elasticity value;
normalization layer: by adjusting an output of a middle layer of the neural network, reducing an internal covariate offset, so that it has a unified scale, thereby accelerating a training speed;
discarding layer: by randomly discarding some neurons in the network, the network becomes sparse, reducing a complex co-adaptation relationship between neurons, and improving a generalization ability of the model;
2) in the RNN layer
recurrent layer: it is composed of a long short-term memory network LSTM or a gated recurrent unit GRU, through memory processing and time series data analysis, processing the features extracted by CNN to predict a future trend and mode of price.

Therefore, the invention adopts the above-mentioned price elasticity analysis and prediction method and model based on deep learning, and the beneficial effects are as follows:
1. By introducing a combination of convolutional neural network CNN and recurrent neural network RNN into the deep learning model, the invention makes full use of the high efficiency of CNN in feature extraction and the ability of RNN in processing time dependence. It not only makes the price elasticity model comprehensive and accurate, but also improves the accuracy, complexity, and reliability of the model, to better analyze market behavior and predict price changes, and help enterprises make more wise decisions.
2. By adding sentiment data and trend data, the invention can provide important input for market analysis, enhance the predictive ability of the price elasticity model, and then provide decision support, such as market prediction, product positioning, marketing strategy, etc.
3. The invention effectively adjusts the learning rate and improves the training effect of the deep learning model by using the Adam algorithm; at the same time, the Adam algorithm combines the advantages of the momentum method and the RMSProp algorithm, which makes the model have better convergence and generalization ability.

The following is a further detailed description of the technical scheme of the invention through drawings and an embodiment.

### BRIEF DESCRIPTION OF THE DRAWINGS

The FIGURE is a method flow chart of the invention.

### DETAILED DESCRIPTION OF THE EMBODIMENTS

The following is a further explanation of the technical scheme of the invention through drawings and embodiments.

Unless otherwise defined, the technical terms or scientific terms used in the invention should be understood by people with general skills in the field to which the invention belongs. The words first, second, and the like used in this invention do not represent any order, quantity, or importance, but are only used to distinguish different components. Similar words such as comprise or comprising mean that the elements or objects appearing before the word cover the elements or objects listed after the word and their equivalents, without excluding other elements or objects. The terms setup, installation, and connection should be understood in a broad sense, for example, it can be fixed connection, detachable connection, or integrated connection, it can be mechanical connection or electrical connection; it can be directly connected or indirectly connected through an intermediate medium, which can be the internal connection of two components. Up, down, left, right, etc. are only used to represent the relative positional relationship, when the absolute position of the described object changes, the relative positional relationship may also change accordingly.

### Embodiment

(I) As shown in the figure, the invention provides a price elasticity analysis and prediction method based on deep learning, comprising the following steps:
S1, the historical data are collected and merged into a multi-dimensional time series dataset;
historical data refers to the data of market prices and demand in the past period, comprising the historical price changes and sales (demand) changes of specific goods or services. Historical data usually exist in the form of time series, recording the value of price and demand at different time points, which can be used to analyze price trends, seasonal patterns, demand fluctuations, etc.
S2, the natural language processing technology is used to extract sentiment data and trend data from market news and social media.

The historical records of price and demand provide a quantitative perspective of market behavior, while news commentary text analysis provides a qualitative perspective of market sentiment and public response.

Text analysis of news commentary, such as sentiment analysis and trend word extraction, can reveal information such as public sentiment and market reaction to specific events. This information helps to understand the reasons behind price and demand changes, such as why demand soars or prices fluctuate during a given period.

By merging these qualitative text analysis results with quantitative historical price and demand data, a more comprehensive market analysis model can be formed. For example, if a news event triggers a strong public sentiment response, this may be reflected in subsequent demand or price changes.

The combination of these two data types (quantitative price/demand data and qualitative news commentary text analysis results) can provide more in-depth insight and help to build a more accurate price elasticity model.
S3, the data obtained by S1 and S2 are input into the convolutional neural network CNN for data preprocessing and feature extraction to capture key information. Specifically:
S31, data cleaning and preprocessing: comprising the removal of stop words, and irrelevant punctuations, and the simplified processing is performed through stemming and word vectorization;
S32, the sentiment prediction is performed through the sentiment analysis model:

### 1) Sentiment Analysis

Sentiment analysis is usually based on word vectors obtained by preprocessing (comprising stemming and word vectorization). These word vectors capture the keywords and their semantic information in the text, which is very important for judging the sentiment trend of the text.

### 2) Method of Emotion Prediction

Sentiment prediction can use a variety of methods, but it is common to use deep learning models, especially recurrent neural networks (RNN) or their variants, such as long-term and short-term memory networks (LSTM) or gated recurrent units (GRU). These networks are well suited for processing sequence data, such as text, because they can remember the previous information in the sequence, which is important for understanding the sentiment context of the entire text.

### 3) Network Structure, Input and Output

Structure: A common sentiment analysis network structure comprises an embedding layer (for further processing of word vectors), one or several LSTM/GRU layers (for processing sequence data), and a dense connection layer (for the final sentiment classification).

Input: The input of the network is preprocessed and vectorized text data, that is, word vector. These vectors are usually of fixed length, if the original text is too long or too short, it may need to be filled or truncated.

Output: The output of the network is the result of sentiment classification, usually a probability distribution, indicating the probability that the text belongs to different sentiment categories (such as positive, negative, and neutral).

For example, for a simple sentiment analysis model, we may first use the pre-processed word vector as input, then process the sequence data through an LSTM layer to capture the time-dependent characteristics in the text, and finally output the sentiment classification results through a dense connection layer.

Such a model can predict the overall sentiment trend based on the keywords in the text data and their context, which is very useful for understanding the sentiment of market participants on specific products or events. Through this method, a large amount of text data can be effectively converted into quantifiable indicators of market sentiment, thus providing important input for market analysis.
S33, trend analysis:

Text mining and machine learning algorithms are used to identify trends and patterns in the market to understand the preferences and behaviors of market participants.

Trends and patterns in the market-specific methods of operation are as follows:

### 1) Feature Extraction

Features are extracted from the preprocessed text data, and the text is converted into a numerical vector using methods such as word bag, TF-IDF, Word2Vec, or BERT.

### 2) Trend Identification and Pattern Analysis

Machine learning algorithms are used to analyze features and identify market trends and patterns. It may comprise:

The classification algorithm (such as support vector machine, random forest, neural network, etc.) is used for sentiment analysis to identify the sentiment trend of market news or posts;
the clustering algorithm (such as K-means, DBSCAN, etc.) is applied to discover different types of market behavior;
the time series analysis method (such as ARIMA, LSTM, etc.) is used to predict price trends or market trends.

### 3) Results Interpretation and Application

The identified pattern is analyzed and explained, the results of machine learning algorithms are linked with market theory and real-world events, and the reasons behind them are understood.

Use these analyses to provide decision support, such as market forecasting, product positioning, marketing strategy, and so on.

These core steps combine text mining and machine learning techniques, making it possible to extract trends and patterns from a large amount of market data, thus providing a solid foundation for in-depth market analysis.
S34, feature extraction: According to the results of sentiment and trend analysis, useful features are extracted from text data. Specifically:
S341, integrating the sentiment analysis results: Each text (such as news articles, and social media posts) obtains a sentiment score through sentiment analysis. This score is usually a numerical value, indicating the sentiment trend of the text, such as positive, negative, or neutral. These sentiment scores are used as features, for example, the average sentiment score can be calculated for each text, or the statistical score can be classified according to the sentiment trend;
S342, integrating trend analysis results: Trend words or phrases identified by trend analysis (such as words related to specific products or market events) are also considered as important features. The frequency of these trend words in each text can be calculated, or the words with abnormally increased frequency can be identified, which are indicators of market trend changes.
S343, constructing a feature vector: The sentiment score and the frequency of trend words are combined into a feature vector. Each text corresponds to a feature vector, which contains the sentiment score and the frequency of key trend words. This feature vector can be used as input to the subsequent machine-learning model for further analysis and prediction;
S344, according to the analysis objective, feature selection and optimization are performed to improve the accuracy and efficiency of the model, comprising removing the noise features and selecting the features that contribute most to the prediction.

The sentiment scores and trend word features extracted from the text can be used to construct more complex analysis models, such as predicting market dynamics and understanding consumer behavior. The combination of these features provides rich information for an in-depth understanding of market trends.
S35, feature fusion: The extracted feature data is fused with the traditional quantitative market data to form a feature set, which increases the dimension of the data. By merging qualitative and quantitative information, the information value of the data is improved, and a more comprehensive market perspective is provided to help more accurately predict market trends and make decisions.

Traditional quantitative market data comprise: price data (such as commodity prices, stock prices), trading volume (such as stock trading volume, market trading volume), economic indicators (such as GDP growth rate, unemployment rate), interest rate data, etc. These data are used to represent specific numerical changes in the market and provide a quantitative description of market behavior. For example, price and trading volume data can be used to analyze market supply and demand, and economic indicators can reflect the overall economic environment.

The steps of feature fusion are as follows:
1) Data alignment: First, ensure that text features and quantitative market data are aligned on the timeline. For example, if the text data is daily, then the market data also needs to be daily, or needs to be aggregated to the daily level;
2) Normalization: The features are normalized and standardized to ensure that the features of different data sources are in the same order of magnitude, so as to avoid the disproportionate influence of some features on the final model;
3) Feature merging: The normalized text features and market data are merged into a unified feature set; this is usually achieved through a simple horizontal connection (such as adding columns to the data table).
S4, the features extracted by the convolutional neural network CNN are input into the recurrent neural network RNN for time series analysis, and the predicted price trend is output.
S5, training and optimizing model: The Adam algorithm is used to adjust the learning rate adaptively, and the momentum method and RMSProp algorithm are combined to improve the generalization ability and prediction accuracy of the model. Specifically:
S51, the model structure is defined and the model parameters are initialized. Comprising the weights and biases of the CNN and RNN layers, these parameters can be randomly initialized, or some pre-trained weights are used as the starting points;
S52, the Adam optimization algorithm is selected: the initial learning rate (e.g. 0.001), momentum parameter (e.g. 0.9), and RMSProp parameter (e.g. 0.999) are set;
S52, the loss function is defined: comprising the mean square error MSE function or the cross entropy loss function, the prediction accuracy of the model is evaluated;
S53, the iterative training is performed for each batch of training data: the data are input into the model, and the forward calculation is performed through the CNN layer and the RNN layer to obtain the prediction result; according to the loss function, the difference between the prediction result of the model and the actual result is calculated; and then the gradient of the loss function relative to each parameter is calculated; finally, the model parameters are updated according to the gradient calculated by the Adam algorithm;
S54, the deviation correction is applied in the Adam algorithm to reduce the impact of initialization;
S55, model evaluation and adjustment: after each iteration cycle, the performance of the model is evaluated by using the validation dataset, and the parameters are adjusted according to the performance of the model on the validation set, such as learning rate adjustment, early stop (to prevent overfitting), etc.;
S56, S53 is repeated until the model performance reaches a satisfactory level or reaches a predetermined number of iterations;
S57, model testing: The final trained model is tested on the testing set to evaluate its performance on unseen data.

(II) The invention also provides a price elasticity analysis prediction model based on deep learning, comprising a convolutional neural network CNN layer for feature extraction and a recurrent neural network RNN layer for prediction;
1) The CNN layer comprises:

The input layer: It is used as the multi-dimensional representation of input time series data, comprising the historical data, sentiment data, and trend data;
the convolution layer: In the price elasticity analysis prediction model, the convolution layer is used to automatically identify and extract the characteristics of the complex relationship between price data and related factors (such as promotional activities, seasonal changes, competitor prices, etc.). By applying several different convolution kernels on the dataset, the model can learn various features from base price changes to complex consumer behavior patterns;
the activation layer: It is after the convolution layer, all negative values are set to zero by introducing ReLU, which increases the nonlinear ability of the model to capture the nonlinear relationship between price and demand, and solves the nonlinear problem of the network; it is essential for understanding and predicting consumers' response to price changes, because this response is often not linear;
the pooling layer: In the form of maximum pooling, the information of adjacent feature points is summarized by taking the maximum or average value, and the most significant part of the feature (such as significant price fluctuations or trends) is extracted to maintain the spatial hierarchy of the feature (i.e., retaining important price change features), the number of parameters and calculations of subsequent layers is reduced, and over-fitting is controlled; it plays the role of dimension reduction and feature enhancement in price elasticity analysis.
the fully connected layer: It is located at the end of the network, by flattening the feature map after several convolutions and pooling into vectors, the impact of price changes on demand is calculated, and the predicted price elasticity value is output;
the normalization layer: By adjusting the output of the middle layer of the neural network, the model maintains stability during the training process and improves the convergence speed. In the price elasticity prediction model, this helps to process input data of different scales and ranges, such as price and sales volume, to ensure the efficiency and accuracy of model training;
the discarding layer: by randomly discarding some neurons in the network, the network becomes sparse, the complex co-adaptation relationship between neurons is reduced, and the generalization ability of the model is improved; this is particularly important in price elasticity analysis, because market data often contain noise and irregularity, and the use of discard layer can improve the generalization ability of the model on unseen data.

The output layer: it is used to output the important patterns and characteristics in the input data.
2) The RNN layer comprises:

Input layer: it is used to input the features extracted by CNN; usually, it is sequence data, such as time series price data, previous market forecasts, etc.;
the recurrent layer is composed of long-term and short-term memory network LSTM or gated recurrent unit GRU. Through memory processing and time series data analysis, the features extracted by CNN are processed to predict the future trend and mode of price;
the recurrent layer: it is composed of a long short-term memory network LSTM or a gated recurrent unit GRU, through memory processing and time series data analysis, the features extracted by CNN are processed to predict the future trend and mode of price;
the output layer: it is used to output the prediction result, such as future price or market behavior prediction.

(III) The invention can be applied to a variety of industries, and the application panorama is very extensive.

It can be applied to various industries and fields, such as retail, e-commerce, energy commodities, etc. By analyzing and predicting price elasticity, enterprises can better understand market demand and consumer behavior, to formulate more accurate pricing strategies and sales strategies.

For example, 1) In the retail industry, it can help companies predict the price elasticity of different products, that is, the sensitivity of price changes to demand. By understanding price elasticity, enterprises can adjust product pricing according to market demand and competition to increase sales and profits. In addition, market news and social media data can also be analyzed to further enhance the predictive power of price elasticity models and help companies more accurately predict price trends and market changes. 2) In the energy commodities industry, it can help companies predict energy price fluctuations and demand changes. By analyzing historical data and market factors, the deep learning model can identify the relationship between price and demand and predict future price trends. This enables companies to make more accurate purchasing decisions and optimize supply chain management, thereby improving operational efficiency and reducing costs.

Therefore, the invention adopts the above-mentioned price elasticity analysis and prediction method and model based on deep learning. By combining the advantages of CNN and RNN, it can understand and predict the complex relationship between price and market behavior more comprehensively and accurately, improve the prediction performance of the price elasticity model, and help enterprises make more informed decisions.

Finally, it should be explained that the above embodiment is only used to explain the technical scheme of the invention rather than restrict it. Although the invention is described in detail concerning the better embodiment, the ordinary technical personnel in this field should understand that they can still modify or replace the technical scheme of the invention, and these modifications or equivalent substitutions cannot make the modified technical scheme out of the spirit and scope of the technical scheme of the invention.

What is claimed is:

1. A price elasticity analysis and prediction method based on deep learning, comprising the following steps:
S1, collecting historical data and merging the historical data into a multi-dimensional time series dataset; the historical data comprise a historical price change and a sales volume change;
S2, using natural language processing technology to extract sentiment data and trend data from market news and social media;
S3, inputting the historical data, the sentiment data, and the trend data obtained by S1 and S2 into a convolutional neural network (CNN) for data preprocessing and feature extraction to capture key information;
S4, inputting a feature extracted by the CNN into a recurrent neural network (RNN) for time series analysis, and outputting a predicted price trend;
S5, training and optimizing model: using an Adam algorithm to adjust a learning rate adaptively, and combining a momentum method and RMSProp algorithm to improve a generalization ability and prediction accuracy of the model.

2. The price elasticity analysis and prediction method based on the deep learning according to claim 1, wherein S3 is as follows:
S31, data cleaning and preprocessing: comprising a removal of stop words, and irrelevant punctuations, and performing a simplified processing through stemming and word vectorization;
S32, performing a sentiment prediction through a sentiment analysis model: inputting preprocessed data, processing sequence data through a long short-term memory (LSTM) layer, capturing a time-dependent characteristic in text data, and finally outputting a result of sentiment classification through a dense connection layer;
S33, trend analysis: using text mining and a machine learning algorithm to identify a trend and pattern in a market; wherein based on the preprocessed data, using a classification algorithm to identify sentiment tendencies, using a clustering algorithm to find different types of market behaviors, and using a time series analysis method to predict the price trend or a market trend;
S34, feature extraction: according to a result of sentiment and trend analysis, extracting useful features from the text data;
S35, feature fusion: fusing extracted feature data with traditional quantitative market data to form a feature set.

3. The price elasticity analysis and prediction method based on the deep learning according to claim 2, wherein S34 is as follows:
S341, integrating a sentiment analysis result: obtaining a sentiment score of each text data, calculating an average sentiment score or classifying the sentiment scores according to a sentiment trend, and obtaining a sentiment characteristic;
S342, integrating a trend analysis result: identifying trend words or phrases, and calculating a frequency of trend words or phrases in each text data, or identifying trend words or phrases with abnormally increased frequency;
S343, constructing a feature vector: merging a frequency of sentiment scores and trend words into a feature vector, and each text data corresponds to a feature vector;
S344, according to an analysis objective, performing a feature selection and optimization.

4. The price elasticity analysis and prediction method based on the deep learning according to claim 3, wherein in S35:
the traditional quantitative market data comprise: price data, trading volume, economic indicators, and interest rate data;
the steps of feature fusion are as follows: performing a data alignment for text data features and quantitative market data on a timeline, normalizing or standardizing the feature data, and merging normalized feature data and quantitative market data into a feature set.

5. The price elasticity analysis and prediction method based on the deep learning according to claim 4, wherein S5 is as follows:
S51, defining a model structure, initializing weights and bias parameters of a CNN layer and an RNN layer in the model;
S52, selecting an Adam optimization algorithm: setting an initial learning rate, a momentum parameter, and a RMSProp parameter;
S52, defining a loss function: comprising a mean square error MSE function or a cross-entropy loss function, evaluating the prediction accuracy of the model;
S53, performing an iterative training for each batch of training data: inputting the training data into the model, and performing a forward calculation through the CNN layer and the RNN layer to obtain a prediction result; according to the loss function, calculating a difference between the prediction result of the model and an actual result; calculating a gradient of the loss function relative to each parameter; and updating model parameters according to the gradient calculated by the Adam algorithm;
S54, applying deviation correction in the Adam algorithm to reduce an impact of initialization;
S55, model evaluation and adjustment: after each iteration cycle, evaluating a performance of the model using a validation dataset, and adjusting parameters according to the performance of the model on the validation dataset;
S56, repeating S53 until a model performance reaches a satisfactory level or reaches a predetermined number of iterations;
S57, model testing: testing a final trained model on a testing set to evaluate a performance of the final trained model on unseen data.

6. A price elasticity analysis prediction model based on deep learning, wherein the price elasticity analysis prediction model comprises a CNN layer for feature extraction and an RNN layer for prediction;
the CNN layer: the CNN layer comprises an input layer, a plurality of convolutional layers for extracting input data features, an activation layer for enabling a network to learn complex patterns, a pooling layer for reducing a spatial dimension of a feature map, a fully connected layer for making final decisions, a normalization layer for improving a convergence speed of a model, a discarding layer for preventing overfitting of the model, and an output layer;
the RNN layer: the RNN layer comprises an input layer for inputting CNN extracted features, a loop layer for processing CNN extracted features, and an output layer for outputting a prediction result.

7. The price elasticity analysis prediction model based on the deep learning according to claim 6, wherein
1) in the CNN layer
a convolution layer: by applying a plurality of different convolution kernels on a dataset, the model learns various features from basic price changes to complex consumer behavior patterns, and automatically identifies and extracts features of a complex relationship between price data and promotions, seasonal changes, and competitor prices;
an activation layer: the activation layer is after the convolution layer, setting all negative values to zero by introducing ReLU, wherein the ReLU increases a nonlinear ability of the model and solves a nonlinear problem of the network;
a pooling layer: in a form of maximum pooling, summarizing information of adjacent feature points by taking a maximum value or average value to extract significant price fluctuations or trend characteristics, retaining important price change characteristics, reducing the number of parameters and calculations of subsequent layers, and controlling over-fitting;
a fully connected layer: the fully connected layer is located at an end of the network, by flattening the feature map after a plurality of convolutions and pooling into vectors, calculating an impact of price changes on demand, and outputting a predicted price elasticity value;
a normalization layer: by adjusting an output of a middle layer of the neural network, reducing an internal covariate offset, wherein the neural network has a unified scale, thereby accelerating a training speed;
a discarding layer: by randomly discarding some neurons in the network, the network becomes sparse, reducing a complex co-adaptation relationship between the neurons, and improving a generalization ability of the model;
2) in the RNN layer
a recurrent layer: the recurrent layer comprises an LSTM network or a gated recurrent unit (GRU), through memory processing and time series data analysis, processing the features extracted by CNN to predict a future trend and mode of price.
